(19) United States
(12) Patent Application Publication
(10) Pub. No.: US 2005/0037822 A1
(43) Pub. Date: Feb. 17, 2005

(54) Antenna steering method and apparatus for an 802.11 station

(75) Inventors: John A. Regnier, Palm Bay, FL (US); Kevin P. Johnson, Palm Bay, FL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: IPR Licensing, Inc., Wilmington, DE (US)

(21) Appl. No.: 10/871,362

(22) Filed: Jun. 18, 2004

Related U.S. Application Data
(60) Provisional application No. 60/479,640, filed on Jun. 19, 2003.

(51) Int. Cl. H04Q 7/20

(52) U.S. Cl. 455/575.5; 455/25; 455/562.1; 455/440

(57) ABSTRACT

A method or apparatus steers a directional antenna for a station to communicate with an Access Point (AP) in an 802.11 protocol system. The method or apparatus may include setting the directional antenna in an omni-directional pattern during a Beacon scan. After authentication with a selected AP, the method or apparatus conducts an antenna beam selection process to determine a “best” direction for communicating with the selected AP based on a metric, such as Signal-to-Noise Ratio (SNR), of the Beacon frames received on each of the directional antenna scan angles. The method or apparatus may be integrated into or associated with a Medium Access Control (MAC) layer and receive signal quality metrics from the Physical (PHY) layer.

### RELATED APPLICATION(S)

This application claims the benefit of U.S. Provisional Application No. 60/479,640, filed Jun. 19, 2003, the entire teachings of which are incorporated herein by reference.

### BACKGROUND OF THE INVENTION

The 802.11 group of IEEE standards allows stations (e.g., portable computers) to be moved within a facility and connect to a Wireless Local Area Network (WLAN) via Radio Frequency (RF) transmissions to Access Points (AP's) connected to a wired network, referred to as a distribution system. A physical layer in the stations and access points provides low level transmission means by which the stations and access points communicate. Above the physical layer is a Media Access Control (MAC) layer that provides services, such as synchronization, authentication, deauthentication, privacy, association, disassociation, etc.

In operation, when a station comes on-line, synchronization is first established between the physical layers in the station and an access point. The MAC layer then associates and authenticates with that AP.

Typically, in 802.11 stations and access points, the physical layer RF signals are transmitted and received by monopole antennas. A monopole antenna radiates in all directions, generally in a horizontal plane for a vertical oriented element. Monopole antennas are susceptible to effects that degrade the quality of communication between the station and the access points, such as reflection or diffraction of radio wave signals the station and the access points, such as reflection or diffraction of radio wave signals caused by intervening objects, such as walls, desks, people, etc. These objects create multi-path, normal statistical fading, Rayleigh fading, and so forth. As a result, efforts have been made to mitigate signal degradation caused by these effects.

One technique for counteracting the degradation of RF signals is to use two antennas to provide spatial diversity using two antennas spaced some distance apart. The two antennas are coupled to an antenna diversity switch in either or both the stations and access points. The theory behind using two antennas for antenna diversity is that, at any given time, one of the two antennas is likely receiving a signal that is not suffering from the effects of, say, multi-path, and that is the antenna that the station or access point selects via the antenna diversity switch for transceiving signals.

### SUMMARY OF A PREFERRED EMBODIMENT

Improvement over simple diversity is provided through a Medium Access Control (MAC) layer antenna steering process for a directional antenna used on the station side of an 802.11 wireless network. The directional antenna provides an improved signal quality in most cases allowing the link to operate at higher data rates.

One embodiment according to the principles of the present invention includes a method or apparatus operating external from a Station Management Entity (SME) and Physical (PHY) layer (e.g., at the MAC layer or in a process in communication with the MAC layer) resident in an 802.11 Network Interface Card in a station. The method or apparatus selects the best directional antenna pattern based on signal quality metrics available from the PHY layer upon reception of frames from the Access Point (AP). The directional antenna may be controlled by a simple two- or three-wire digital interface that drives switches connected to passive or active elements of the directional antenna to cause the directional antenna to form the selected beam pattern. The directional antenna can also be placed in an omni-mode with near equal gain in all directions.

The station surveys the available Access Points by detecting Beacon Frames in omni-directional mode. During synchronization with a particular access point, Beacon frames may be used to perform a search for a “best” antenna direction. The method or apparatus may further include revisiting the omni-directional mode during the reception of the Beacon frame to determine if the advantage of operating in the selected “best” antenna direction is retained. If not, a subsequent search for a “best” antenna direction is performed.

The method or apparatus may also use a series of probe requests to cause a predefined response from an AP. The antenna beam pattern changed between each probe request to determine the best antenna beam pattern. In this way, Beacon frames are not missed should the antenna beam be pointing in a direction away from the AP during the Beacon frame.

The benefits from augmenting the station with a directional antenna are two-fold: (i) improved throughput to individual stations and (ii) ability to support more users in the network. In most RF environments, the signal level received at the station can be improved by orienting a shaped antenna beam in the direction of the strongest signal. The shaped beam provides 3-5 dB additional gain over the omni-directional (“omni”) antennas typically employed. The increased signal level allows the access point and the station to transmit at higher data rates, especially at the outer edge of the coverage area. This improves the throughput to/from that station but also increases the network capacity since the transmission time is reduced. For example, if the access point and the connected stations are able to cut their transmission times in half by employing a higher data rate, the network is able to support twice as many users.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1A is a schematic diagram of a Wireless Local Area Network (WLAN) employing the principles of the present invention;

FIG. 1B is a schematic diagram of a station in the WLAN of FIG. 1A performing an antenna scan;

FIG. 2A is an isometric view of a station of FIG. 1A having an external directive antenna array;

FIG. 2B is an isometric view of the station of FIG. 2A having the directive antenna array incorporated in an internal PCMCIA card;

FIG. 3A is an isometric view of the directive antenna array of FIG. 2A;

FIG. 3B is a schematic diagram of a switch used to select a state of an antenna element of the directive antenna of FIG. 3A;

FIG. 4 is a layer reference model including a Station Management Entity (SME) Media Access Control (MAC) layer, and Physical (PHY) layer operating in the stations of FIG. 1A,

FIG. 5 is a high-level schematic diagram of the layers of FIG. 4 operating with the directional antenna of FIG. 2A;

FIG. 6 is a message sequence chart illustrating messages communicated among the layers of FIG. 4; and

FIG. 7 is a flow diagram of a process for performing the antenna beam selection of FIG. 1B.

### DETAILED DESCRIPTION OF THE PREFERRED EMBODIMENT

A description of preferred embodiments of the invention follows.

Directional antennas have traditionally been employed to improve signal quality over line-of-sight RF communications links. The directional antenna uses some form of beam-forming to increase the antenna gain in a particular direction for transmission and reception. The direction may be adjusted or chosen to improve signal quality. In application to the 802.11 wireless access media, the directional antenna provides gain as well as interference rejection and angular diversity. The present invention provides a method to determine the best pointing angle of a directional antenna within the 802.11 MAC layer protocols.

The ability of a directional antenna to provide an increase in signal quality, i.e., Signal-to-Noise Ratio (SNR), is statistical in nature. In some multi-path environments, a directional antenna may provide more than 5 dB of gain, and in others, it may not be better than an omni-directional (“omni”) pattern. Averaging over the whole network coverage area, a system employing an directional antenna might obtain a 10 dB increase in gain about 10% of the time, a 5 dB in gain about 30% of the time, etc. The amount of gain translates into how much data throughput can be increased. For an 802.11b link, for example, the system might need 6 dB of gain to achieve the normally expected maximum 11 Mbps data rate versus the lowest 1 Mbps rate at the edge of the coverage area. For an 802.11a or 802.11g link, the system might need more than 10 dB of gain to achieve the highest data rate of 54 Mbps.

Typically, the control messages (including the Beacon frames) are sent from the Access Point (AP) at the lowest data rate so that all of the stations in the coverage area can correctly receive them. Data frames sent from the access point to a single station can be sent at higher data rates to improve the network efficiency. The means by which the access point decides it can transmit at the higher rates to a specific station is not specified in the 802.11 standards.

Since one objective of the directional antenna is to provide increased throughput for the data frames sent to or from a station, and since most if not all of the antenna gain is used to provide that increase, a station can operate in directional mode following synchronization with a particular access point and have the benefits of the increased throughput. This simplifies the process and keeps the beacon scan time associated with looking for access points consistent with traditional omni antenna equipped stations.

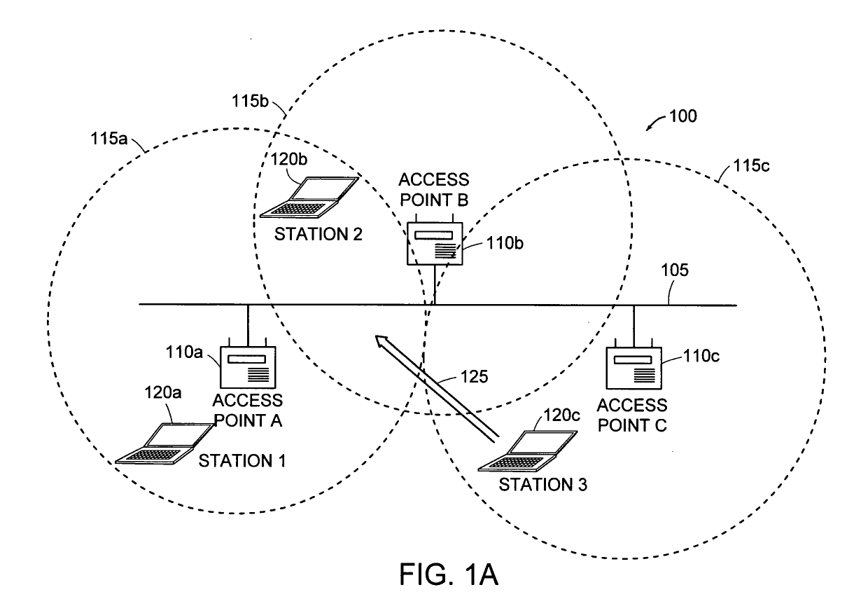

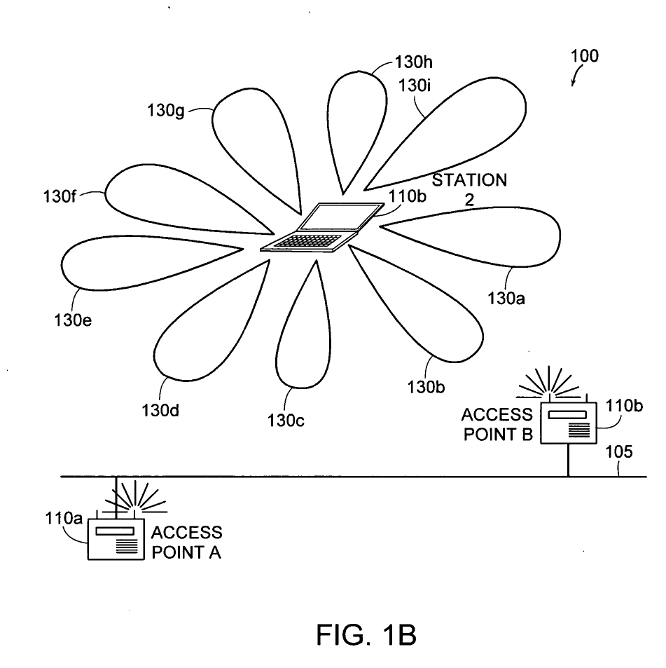

FIG. 1A is a block diagram of a wireless local area network (WLAN) 100 having a distribution system 105, such as a wired network. Access points 110a, 110b, and 110c are connected to the distribution system 105 via wired connections. Each of the access points 110 has a respective zone 115a, 115b, 115c in which it is capable of transmitting and receiving RF signals with stations 120a, 120b, 120c, which are supported with wireless local area network hardware and software to access the distribution system 105.

Present technology provides the access points 110 and stations 120 with antenna diversity. The antenna diversity allows the access points 110 and stations 120 with an ability to select one of two antennas to provide transmit and receive duties based on the quality of signal being received. One antenna is selected over another if, in the event of multi-path fading, a signal taking two different paths to the antennas causes signal cancellation to occur at one antenna but not the other. Another example is when interference is caused by two different signals received at the same antenna. Yet another reason for selecting one of the two antennas is due to a changing environment, such as when a station 120c is moved between the third zone 115c and first or second zones 120a, 120b, respectively.

FIG. 1B is a block diagram of a subset of the network 100 in which the second station 120b, employing the principles of the present invention, is shown in more detail with indications of directive antenna lobes 130a-130i (collectively, lobes 130). After receiving a Join Request from the Station Management Entity (SME), the second station 120b generates or forms the lobes 130 during an antenna search to determine the best direction to the selected access point 110a. The antenna search may be done in a passive mode in which the second station 120b listens for Beacons emitted by the access point 110a. In 802.11 systems, the Beacons are generally sent every 100 msec. So, for the nine antenna lobes 130, the process takes about 1 second to scan through the antenna directions and determine the best angle. In an active scan mode, the second station 120b sends a probe to the selected access point 110a and receives responses to the probes from the access point 110a. This probe and response process is repeated for each antenna scan angle.

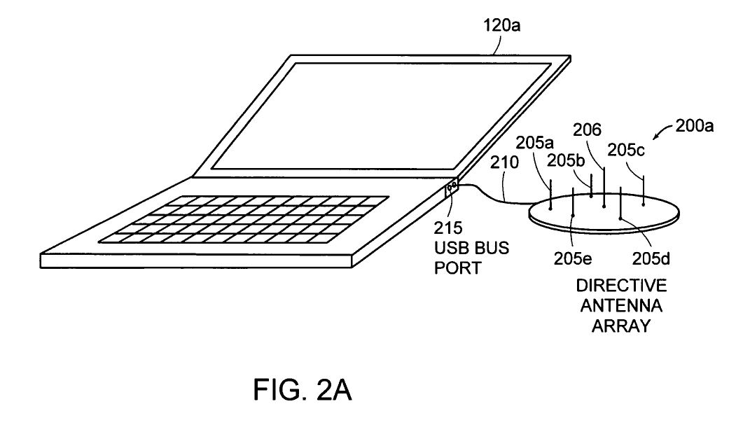

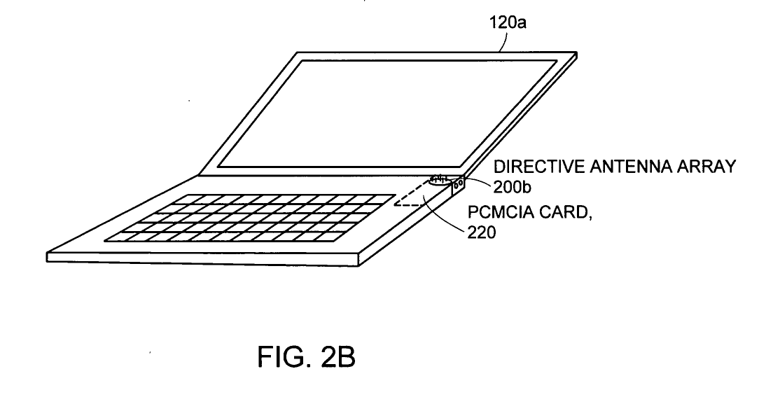

During an antenna search, the second station 120b uses a directive antenna, shown in more detail in FIGS. 2A and 2B, in search of signals from the access points 110. At each beam position, the second station 110b measures the received beacon or probe response and calculates a respective metric for that directional beam. Examples of the metrics include Received Signal Strength Intensity (RSSI), Carrier-to-Interference ratio (C/I), Signal-to-Noise Ratio (SNR), Energy-per-bit per total Noise (Eb/No), or some other suitable measure of the quality of the received signal or signal environment. Based on the metrics, the second station 120b can determine a “best” direction to communicate with the access point 110a selected by the SME.

The beam selection search may occur before or after the second station 110b has authenticated and associated with the distribution system 105. Thus, the initial antenna scan may be accomplished within the Media Access Control (MAC) layer. Similarly, beam selection search occurring after the second station 120b has authenticated and associated with the distribution system 105 may be accomplished within the MAC.

FIG. 2A is a diagram of the first station 120a that uses a directive antenna array 200a (interchangeably referred to herein as a directional antenna 200a) that is external from the chassis of the first station 120a. The directive antenna array 200a includes five monopole passive antenna elements 205a, 205b, 205c, 205d, and 205e (collectively, passive antenna elements 205) and one monopole, active antenna element 206. The directive antenna element 200a is connected to the station 120a via a universal system bus (USB) port 215. The antennas 205 in the directive antenna array 200a are parasitically coupled to the active antenna element 206 to allow scanning of the directive antenna array 200a. By scanning, it is meant that at least one antenna beam of the directive antenna array 200a can be rotated, optionally as much as 360 degrees, in increments associated with the number of passive antenna elements 205. A detailed discussion of the directive antenna array 200a is provided in U.S. Patent Publication No. 2002/0008672, published Jan. 24, 2002, entitled “Adaptive Antenna for Use in Wireless Communications System,” the entire teachings of which are incorporated herein by reference. Example methods for optimizing antenna direction based on received or transmitted signals by the directive antenna array 200a are also discussed therein and incorporated herein by reference in their entirety.

The directive antenna array 200a may also be used in an omni-directional mode to provide an omni-directional antenna pattern (not shown). The stations 120 may use an omni-directional pattern prior to sending a transmission for determining whether another station 120 is currently sending a transmission (i.e., Carrier Sense Multiple Access (CSMA)). The stations 120 may also use the selected directional antenna when transmitting to or receiving from the access points 110. In an ‘ad hoc’ network, the stations 120 may revert to an omni-only antenna configuration, since they can receive from any other station 120.

FIG. 2B is an isometric view of the first station 120a. In this embodiment, a directive antenna array 200b is deployed on a Personal Computer Memory Card International Association (PCMCIA) card 220. The PCMCIA card 220 is disposed in the chassis of the first station 120a in a typical manner to a processor (not shown) in the first station 120a. The directive antenna array 200b provides the same functionality as the directive antenna array 200a discussed above in reference to FIG. 2A.

It should be understood that various other forms of directive antenna arrays can be used. Examples include the arrays described in U.S. Pat. No. 6,515,635 issued Feb. 4, 2003, entitled “Adaptive Antenna for Use in Wireless Communication Systems,” and U.S. Patent Publication No. 2002/0036586, published Mar. 28, 2002, entitled “Adaptive Antenna for Use in Wireless Communication System;” the entire teachings of both are incorporated herein by reference.

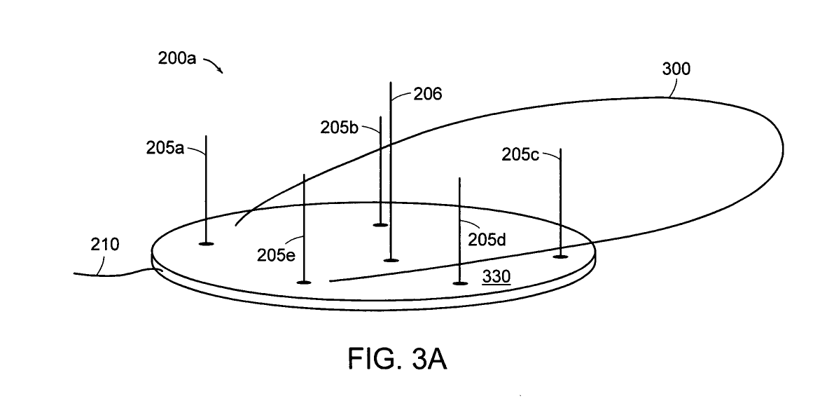

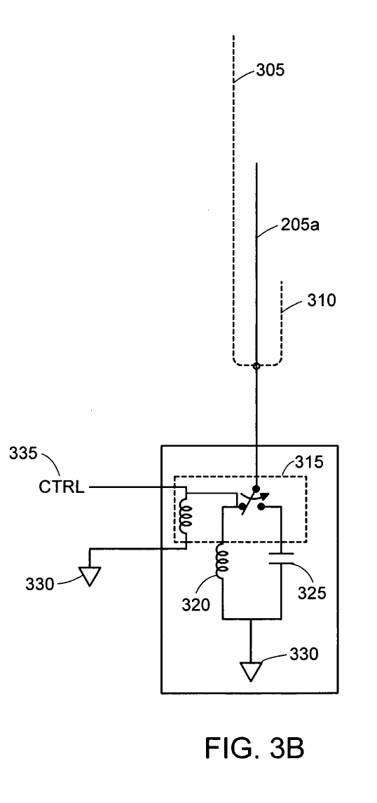

FIG. 3A is a detailed view of the directive antenna array 200a that includes the passive antenna elements 205 and active antenna element 206 discussed above. The directive antenna array 200a also includes a ground plane 330 to which the passive antenna elements are electrically coupled, as discussed below in reference to FIG. 3B.

The directive antenna array 200a provides a directive antenna lobe 300 angled away from antenna elements 205a and 205e. This is an indication that the antenna elements 205a and 205e are in a “reflective” mode, and the antenna elements 205b, 205c, and 205d are in a “transmissive” mode. In other words, the mutual coupling between the active antenna element 206 and the passive antenna elements 205 allows the directive antenna array 200a to scan the directive antenna lobe 300, which, in this case, is directed as shown as a result of the modes in which the passive elements 205 are set. Different mode combinations of passive antenna elements 205 result in different antenna lobe 300 patterns and angles.

FIG. 3B is a schematic diagram of an example circuit that can be used to set the passive antenna elements 205 in the reflective or transmissive modes. The reflective mode is indicated by a representative “elongation” dashed line 305, and the transmissive mode is indicated by a “shortened” dashed line 310. The representative dashed lines 305 and 310 are caused by coupling to a ground plane 330 via an inductive element 320 or capacitive element 325, respectively. The coupling of the passive antenna element 205a through the inductive element 320 or capacitive element 325 is done via a switch 315. The switch may be a mechanical or electrical switch capable of coupling the passive antenna element 205a to the ground plane 330 in a manner suitable for this application. The switch 315 is set via a control signal 335 in a typical switch control manner.

Coupled to the ground plane 330 via the inductor 320, the passive antenna element 205a is effectively elongated as shown by the longer representative dashed line 305. This can be viewed as providing a “backboard” for an RF signal coupled to the passive antenna element 205a via mutual coupling with the active antenna element 206. In the case of FIG. 3A, both passive antenna elements 205a and 205e are connected to the ground plane 330 via respective inductive elements 320. At the same time, in the example of FIG. 3A, the other passive antenna elements 205b, 205c, and 205d are electrically connected to the ground plane 330 via respective capacitive elements 325. The capacitive coupling effectively shortens the passive antenna elements as represented by the shorter representative dashed line 310. Capacitively coupling all of the passive elements 325 effectively makes the directive antenna array 200a into an omni-directional antenna.

It should be understood that alternative coupling techniques may also be used between the passive antenna elements 205 and ground plane 330, such as delay lines and lumped impedances.

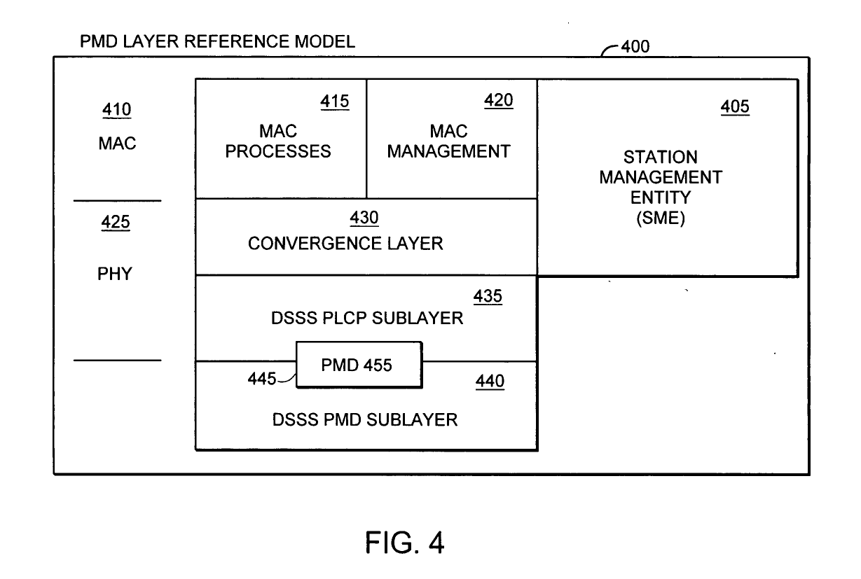

FIG. 4 is a diagram of a physical Medium Dependent (PMD) layer reference model 400. The model 400 indicates the relationships among a Station Management Entity (SME) 405, Medium Access Control (MAC) Layer 410, and Physical (PHY) Layer 425. The SME 405 is typically software executing in the computer portion of the station 120a. The MAC layer 410 and PHY layer 425 are typically firmware operating in circuits in a Wireless Network Interface card, such as the PCIMCIA card 220.

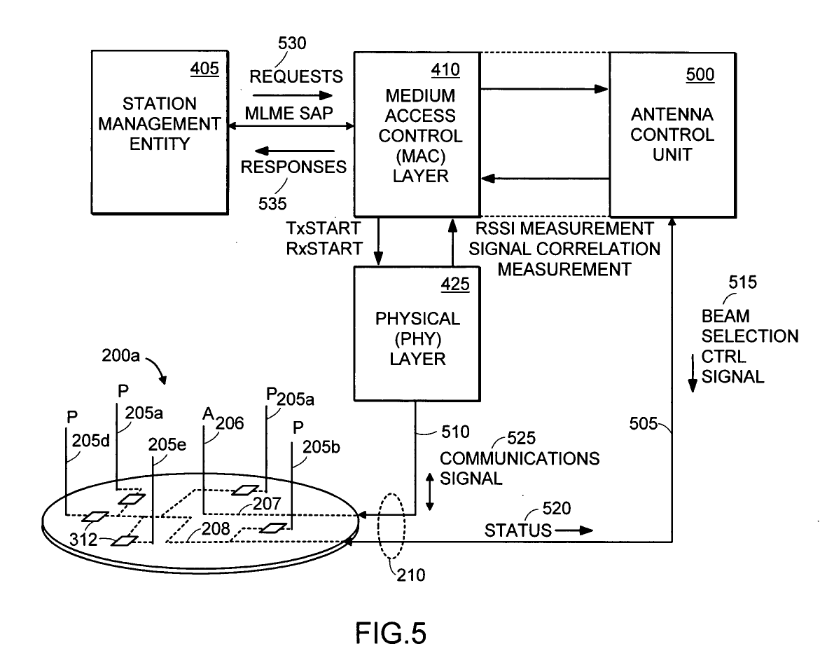

The MAC layer 410 includes MAC processes 415 and MAC management 420. The PHY layer 425 includes a convergence layer 430, Direct Sequence Spread Spectrum (DSSS) Physical Layer Convergence Procedure (PLCP) sublayer 435, a DSSS Physical Medium Dependent (PMD) sublayer, which define a PMD Service Access Point (SAP). The operation of each of the components of the MAC and PHY layers 410, 425 is well known in the art. The purpose of introducing the MAC and PHY layers 410, 425 is to provide an understanding as to how an antenna control unit 500 described in reference to FIG. 5 is integrated into the station 120a in association with the MAC layer.

As shown in FIG. 5, the antenna control unit 500 is integrated into the MAC layer, as indicated by dashed lines 502 or is in communication with the MAC layer 410 via communications paths 504. The antenna control unit 500 is also in communication with impedance devices 312 that determine the RF properties of associated passive antenna element 205, or active antenna elements in an alternative embodiment (e.g., all active antenna array). The antenna control unit 500 may send beam selection control signals 515 via a control cable 505 and receive status information 520 via the same cable 505. The PHY layer 425 communicates with the active antenna elements 206 of the directional antenna 200a with communications signals 525 via a communications cable 510.

In an alternative embodiment, the control unit 500 sends the beam selection control signals 515 to the directional antenna 200a via the PHY layer 425. In such an embodiment, the PHY layer 425 is modified to accommodate a signal feedthrough or support, and the cable 505 extends between the PHY layer 425 and the directional antenna 200a.

The antenna control unit 500, which may be hardware, firmware, or software, is integrated into or alongside the MAC layer 410 and receives indications from the MAC 410 when certain messages are received from the SME 504 or the PHY layer 425. The responses by the antenna control unit 500 to certain SME requests 530 are listed in Table 1.

TABLE 1
Antenna Control Function Response to MAC Layer
Management Entity Commands

| MLME Command | Antenna Control Function |
|---|---|
| ResetRequest | Set Omni Mode |
| StartRequest | Set Omni Mode |
| ScanRequest | Set Omni Mode |
| JoinRequest | Perform Antenna Search |
| | Set Best Directional Mode |

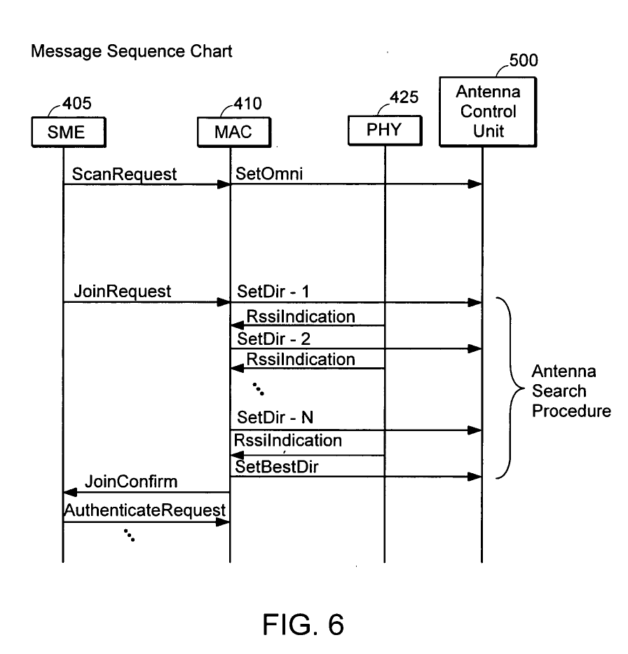

During initialization of the station 120, the ResetRequest, StartRequest, and ScanRequest cause the antenna control unit 500 to revert to the directional antenna's Omni mode. The JoinRequest triggers the antenna search, which is further illustrated in FIG. 6.

Referring now to FIG. 6, each directional antenna beam 130a, 130b, . . . , 130i is selected either prior to a beacon frame or prior to a probe request. The Received Signal Strength Intensity (RSSI) and/or signal correlation measurements from the PHY layer 425 are passed to the antenna control unit 500 when the beacon frame or probe response frame is received. In this embodiment, the probe request is generated by the antenna control unit 500. Once the measurements for all directional beams 130 are complete, a decision is formed to select the best directional mode of the antenna 200a. The antenna control unit 500 then informs the MAC 410 that the JoinConfirm response can be sent to the SME 405 to complete the synchronization process 720 with the selected Access Point 110.

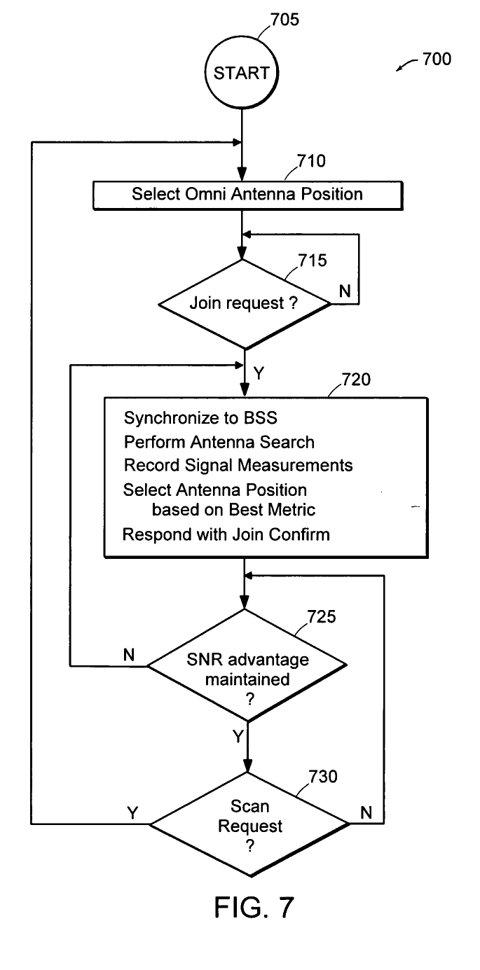

FIG. 7 is an embodiment of a MAC-based process 700 associated with the principles of the present invention. Following start up, (step 705) the MAC-based process 700 at the station 120 selects the omni antenna pattern (Step 710) and waits for a scan request 700 from the Station Management Entity (SME) 405. The omni pattern is employed throughout the Beacon scan time (i.e., the time during which the station locates a “best” access point 110). The results of the Beacon scan are reported back to the SME 405 to select the access point 110 with which it would like to associate. A Join Request command is sent to the MAC 410 to initiate synchronization with the selected Access Point 110 (Step 710). At this point (Step 715), the MAC-based beam selection 700 process performs an initial antenna search for the best directional pattern 130 (step 720). The process 700 records the signal quality of the beacon frames received on each of the potential antenna directions including omni (step 720). Recording the signal qualities may take less than one second to determine the best directional pattern based on a beacon interval of 100 msec (step 720). At this point, the station 120 receives and transmits on the selected antenna direction and sends the Join Confirm indication to the SME (step 720). The selected antenna direction is maintained until a ResetRequest or ScanRequest is received from the SME or the Antenna Control Unit decides to update the antenna selection by performing another antenna search.

One way to determine if the antenna selection should be updated is by monitoring the difference in received signal quality between the directional selection and the omni pattern. This difference, perhaps 4-5 dB, can be recorded when the antenna direction is selected. Thereafter, a predetermined percentage of the Beacon frames may be received using the omni pattern by switching to the omni pattern at known Beacon frame transmission times. The signal quality of these frames are then compared with those received on the directional pattern to check if the signal quality advantage of the directional pattern had degraded (Steps 725 and 730) below a predetermined threshold.

Alternatively, the antenna control may initiate probe requests for determining the best antenna beam. This allows a faster search through the antenna beams 130. Additionally, the probe requests technique eliminates the potential loss of beacon frames that could occur when cycling through the antenna beams 130 on those frames.

Alternatively, antenna directional selection may automatically occur on an event-driven basis, periodically, or randomly.

Depending on the variability of the detected signal and noise levels at the fringes of the coverage area, the process may average multiple signal quality measurements at each antenna direction.

At the point where the antenna search is performed (Step 3), the process may optionally select the omni antenna pattern when signal quality obtained is high enough to support the highest data rate. This occurs when the station is close to the access point.

While this invention has been particularly shown and described with references to preferred embodiments thereof, it will be understood by those skilled in the art that various changes in form and details may be made therein without departing from the scope of the invention encompassed by the appended claims.

1. A method for operating a directional antenna at a Station within a wireless network comprising:
external from a Station Management Entity (SME) and Physical (PHY) layer in a station in a wireless network, selecting an antenna beam pattern for a directional antenna associated with the station based on at least one signal quality metric available from the PHY layer; and
causing the directional antenna to form the selected beam pattern for communicating with a network device external from the station in the wireless network.

2. The method according to claim 1 wherein selecting an antenna beam pattern occurs in a Medium Access Control (MAC) layer.

3. The method according to claim 1 wherein selecting an antenna beam pattern is performed by a process in communication with a Medium Access Control (MAC) layer.

4. The method according to claim 1 wherein selecting an antenna beam pattern is performed as a function of a request from the SME.

5. The method according to claim 4 wherein selecting the antenna beam pattern includes selecting multiple antenna beam patterns as part of an antenna search process.

6. The method according to claim 1 wherein selecting an antenna beam pattern is in response to certain SME requests to a MAC Layer Management Entity (MLME) to select a best antenna beam pattern.

7. The method according to claim 1 wherein selecting the antenna beam pattern includes sequencing through the available multiple antenna beam patterns and causing the directional antenna to form the antenna beam patterns in a manner allowing for the PHY layer to calculate respective signal quality metrics associated with each of the multiple antenna beam patterns.

8. The method according to claim 1 executed in response to a ‘join request’ from the SME.

9. The method according to claim 1 executed to determine whether a communication path between the station and the network device can be improved.

10. The method according to claim 1 executed to in response to a ‘reset request’, ‘start request’, or ‘scan request’ wherein the omni pattern of the directional antenna is automatically selected.

11. The method according to claim 1 wherein the at least one signal quality metric is deemed high enough to select the omni pattern of the directional antenna.

12. The method according to claim 1 wherein causing the directional antenna to form the selected antenna beam pattern occurs during a beacon frame.

13. The method according to claim 1 further including sending a probe request to the network device and causing the directional antenna to form the selected antenna beam pattern during a response to the probe request.

14. The method according to claim 1 wherein the at least one metric is calculated as a function of a beacon frame or, in response to sending a probe request from the station to the network device, as a function of a probe response frame sent from the network node to the station.

15. The method according to claim 1 wherein the wireless device is an Access Point (AP).

16. The method according to claim 1 operating in an 802.11 network.

17. An apparatus for operating a directional antenna in a wireless network, comprising:
a selector external from a Station Management Entity (SME) and Physical (PHY) layer in a station in a wireless network that selects an antenna beam pattern for a directional antenna associated with the station based on at least one signal quality metric available from the PHY layer; and
an antenna control unit that causes the directional antenna to form the selected beam pattern for communicating with a network device in the wireless network.

18. The apparatus according to claim 17 wherein the selector is in a Medium Access Control (MAC) layer.

19. The apparatus according to claim 17 wherein the selector is external from the Medium Access Control (MAC) layer.

20. The apparatus according to claim 17 wherein the selector selects the antenna beam pattern as a function of a request from the SME.

21. The apparatus according to claim 20 wherein the selector selects multiple antenna beam patterns as part of an antenna search process.

22. The apparatus according to claim 17 wherein the selector selects an antenna beam pattern in response to certain SME requests to a MAC Layer Management Entity (MLME) to select a best antenna beam pattern.

23. The apparatus according to claim 17 wherein the selector sequences through the available multiple antenna beam patterns and the antenna control unit causes the directional antenna to form the antenna beam patterns in a manner allowing for the PHY layer to calculate respective signal quality metrics associated with each of the multiple antenna beam patterns.

24. The apparatus according to claim 17 wherein the selector selects the antenna beam pattern in response to a ‘join request’ from the SME.

25. The apparatus according to claim 17 executing an antenna search to determine whether a communication path between the station and network device can be improved.

26. The apparatus according to claim 17 wherein the selector selects an antenna beam pattern in response to a ‘reset request’, ‘start request’, or ‘scan request’ wherein the omni pattern of the directional antenna is automatically selected.

27. The apparatus according to claim 17 wherein the at least one signal quality metric is deemed high enough for the selector to select the omni pattern of the directional antenna.

28. The apparatus according to claim 17 wherein the antenna control unit causes the directional antenna to form the selected antenna beam pattern during a beacon frame.

29. The apparatus according to claim 17 wherein the station sends a probe request to the network device and the antenna control unit causes the directional antenna to form the selected antenna beam pattern during a response to the probe request.

30. The method according to claim 17 wherein the at least one metric is calculated as a function of a beacon frame or, in response to sending a probe request from the station to the network device, as a function of a probe response frame sent from the network node to the station.

31. The apparatus according to claim 17 wherein the wireless device is an Access Point (AP).

32. The apparatus according to claim 17 operating in an 802.11 network.

33. An apparatus for operating a directional antenna in a wireless network, comprising:
external from a Station Management Entity (SME) and Physical (PHY) layer in a station in a wireless network, means for selecting an antenna beam pattern for a directional antenna associated with the station based on at least one signal quality metric available from the PHY layer; and
means for causing the directional antenna to form the selected beam pattern for communicating with a network device in the wireless network.
